(19) United States
(12) Patent Application Publication
(10) Pub. No.: US 2011/0101688 A1
(43) Pub. Date: May 5, 2011

(54) Multi purpose variable speed wind powered generator

(76) Inventor: John Michael McDuffie, Marco Island, FL (US)

(21) Appl. No.: 12/590,194

(22) Filed: Nov. 4, 2009

(51) Int. Cl. F03D 7/04; F03D 9/00

(52) U.S. Cl. 290/44; 416/41

(57) ABSTRACT

A Multi Purpose Variable Speed Wind Powered Generator is configured to generate electrical power to all types of transportation and equipment in any wind condition. The wind speed monitor gives the variable pitch rotor the precise angle of attack to keep rotor RPM relative and stable at all wind speeds. A wind diverter keeps wind flowing through rotors with out wind back up or bottleneck. An onboard trip computer responds in like sequence in union with the wind monitor and rotors through out each trip. The onboard trip computer is designed to maintain rotor RPM as if the transpiration was moving from 10 to 40 miles per hour. The pitch changes as the wind speed changes keeping the rotor RPM relative. Rotor brakes are to slow or stop rotors movement at any time for any reason.

### BACKGROUND OF INVENTION

1. Field of invention

The present invention relates to a wind generator more practically, to a multi purpose variable speed wind powered generator designed to power all forms of transportation and equipment in all wind speeds.

2. Description of the related art

The wind-powered generator is used to generate electrical current for use in all transportation and equipment. The transportation can be initially powered using a combustible engine, a pre-charged battery, or the transportation can be faced into a head wind. Prevailing winds push against the rotors generating power to charge batteries. Once batteries are charged, the transportation or equipment unit can be moved under its own electrical power. As it moves forward, the wind speed turns the rotors, generating ample electrical power to charge batteries, accelerate, and power luxury equipment. As wind speed increases to above 30 miles per hour, the wind speed activates the variable pitch in the rotors which decreases pitch to slow bearing RPM to prevent melt down. This variable speed modulation controls the blades angle of attack, which in turn controls the RPM of the rotor. As the wind speed increases even further, again wind speed activates the variable pitch in the rotors, once again decreasing pitch to keep RPM relative. The rotor pitch is changed by the wind passing through the wind speed monitor. At extreme wind speeds, rotor pitch is reduced to a neutral to keep RPM relative. The onboard trip computer responds in like sequence in union with wind monitor and rotors through out each trip. Rotor brakes are to slow or stop rotors movement at any time for any reason.

### SUMMARY OF THE INVENTION

The present invention has been accomplished under the circumstances in view. The countries need to brake free from foreign oil companies grasps. It is one object of the present invention to start this process. The Multi Purpose Variable Speed Wind Powered Generator will get the winds of change blowing in this direction. This invention introduces a new concept for a very old idea, while avoiding limitations with prior applications of wind-powered generation. It is not a control system for a vertical axis windmill. It allows the wind speed to change the pitch of the variable speed rotor and keep RPM relative. It is designed to power all forms of transportation and equipment in all wind speeds.

To achieve this and other objectives of the present invention the multi purpose variable speed wind generator comprises an automobile chassis for a base frame. The wind blows through the grill, wind speed is monitored and the proper pitch is given to the rotor to keep RPM relative. As the rotor turns, electric power is generated. The power is used to recharge batteries, power luxuries and for acceleration. Wind passing the rotors is then directed back out side the unit by an arrow shaped wind diverter, allowing for proper airflow. As the wind speed increases to above 30 MPH, the wind speed monitor activates the variable pitch in the rotors which decreases pitch and slows bearing RPM to prevent melt down. This variable speed modulation controls the blades angle of attack, which in turn controls the RPM of the rotor. As the wind speed increases even further, again wind speed monitor activates the variable pitch in the rotors decreasing pitch to keep RPM relative. The onboard trip computer responds in like sequence in union with wind speed monitor and rotors through out each trip. Rotor brakes are to slow or stop rotors movement at any time for any reason.

### BRIEF DESCRIPTION OF DRAWINGS

FIG. 1 is a top view of the present invention.

### DETAILED DESCRIPTION OF THE DRAWINGS

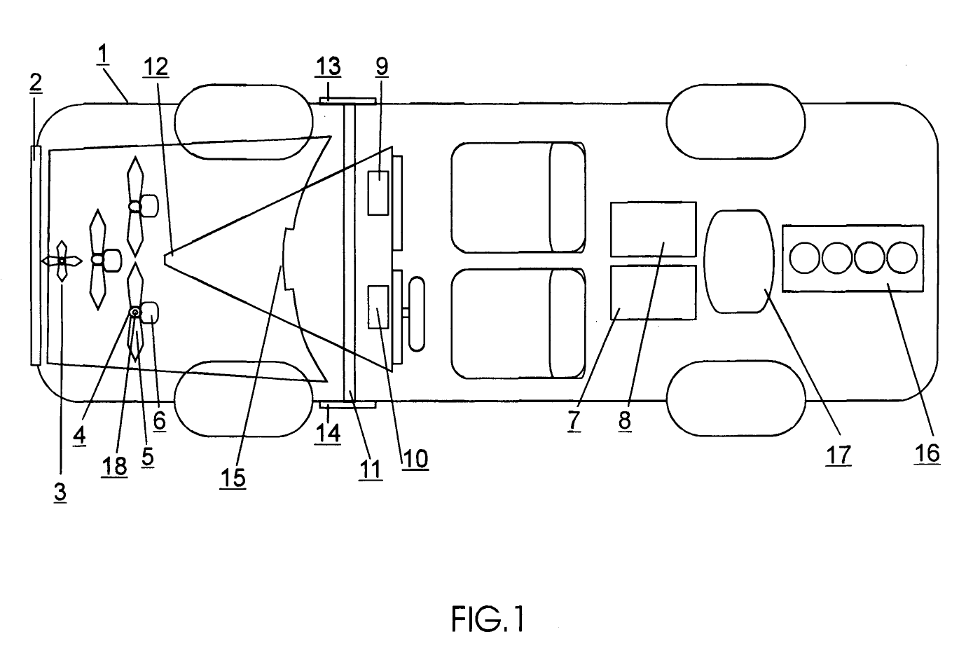

Referring to FIG. 1 of the Multi Purpose Variable Speed Wind Powered Generator in accordance with the present invention is shown comprising an automobile chassis for a base frame 1. The wind blows through the grill 2, hitting wind speed monitored 3. Rotor spins 4, pitch of the blade is changed 5, and generator 6 generates power. Main batteries 7 are charged, the auxiliary batteries 8 are charged, and the onboard trip computer 9 keeps in sink. The instrument panel displays luxury equipment 10. The passenger compartment is elongated in front of the windshield 11 is shaped like an arrow giving more storage space and is an aerodynamic wind diversion 12. The right fender wind diversion vent 13, Left fender wind diversion vent 14, hood diversion vent 15 to better enhancing airflow. Used, as needed the combustion engine 16, and the electric motor 17. Rotor brakes 18 are to slow or stop at any time for any reason.

Particular embodiments of the invention have been described in some detail for the purpose of illustration; however, the invention is not limited to the embodiments of a car or a rotor blade described above. On the contrary, the invention extends to any variant that produces the above described essentials characteristics by any equivalent means.

1. The Multi Purpose Variable Speed Wind Powered Generator is designed to power all forms of transportation and equipment in all wind speeds. The wind blows through the grill, wind speed is monitored and the proper pitch is given to the rotor to keep RPM relative. As the rotor turns, electric power is generated, used to recharge batteries, power luxuries and for acceleration. Wind passing through the rotors is then directed back out side the unit by an arrow shaped wind diverter, allowing for proper airflow. As the wind speed increases to above 30 MPH the wind speed monitor activates the variable pitch in the rotors which decreases pitch to slow bearing RPM to prevent melt down. This variable speed modulation controls the blades angle of attack, which in turn controls the RPM of the rotor. As the wind speed increases even further, again wind speed monitor activates the variable pitch in the rotor decreasing pitch to keep RPM relative. The onboard trip computer responds in like sequence in union with wind monitor and rotors through out each trip. Rotor brakes are to slow or stop rotors movement at any time for any reason.
